(19) United States
(12) Patent Application Publication
(10) Pub. No.: US 2015/0012425 A1
(43) Pub. Date: Jan. 8, 2015

(54) INTELLIGENT ADVICE AND PAYMENT ROUTING ENGINE

(71) Applicant: MasterCard International Incorporated, Purchase, NY (US)

(72) Inventor: Bejoy Mathew, Dardenne Prairie, MO (US)

(21) Appl. No.: 13/936,591

(22) Filed: Jul. 8, 2013

(51) Int. Cl. G06Q 20/22; G06Q 20/36

(52) U.S. Cl. CPC G06Q 20/227; G06Q 20/36
USPC 705/41; 705/39

(57) ABSTRACT

Methods, apparatus and systems include an intelligent decision engine that analyzes data associated with the payment card accounts of a consumer along with other information regarding a particular transaction, and then provides a recommendation to a cardholder concerning which payment card account(s) to use to maximize value. In an embodiment, a processor receives service call data associated with a purchase transaction, determines that a cardholder is a registered smart preferences user, and accesses smart preferences cardholder profile data. The processor then determines a recommendation of at least one payment card account to select for use in the purchase transaction, and transmits the recommendation to a device for consideration and selection of a payment card account by the cardholder.

### FIELD OF THE INVENTION

Embodiments disclosed herein relate to methods, apparatus and systems that include an intelligent decision engine that analyzes data associated with the payment card accounts of a consumer along with other information regarding a particular transaction, and then provides a recommendation to a cardholder concerning which payment card account(s) to use to maximize value.

### BACKGROUND

Payment card systems are in widespread use. A prominent payment card system is operated by the assignee hereof, MasterCard International Incorporated, and by its member financial institutions. FIG. 1 schematically illustrates a typical transaction, as carried out by using a conventional payment system 100. To initiate the transaction, a customer (not shown) visits a retail store (not shown) operated by a merchant, selects goods (not shown) that he/she wishes to purchase, carries the goods to the merchant's point of sale terminal 104, and presents his/her payment card 102 to the point of sale terminal 104. The point of sale terminal 104 reads the customer's payment card account number from the payment card 102, and then sends an authorization request to an acquirer financial institution (FI) 106 with which the merchant has a relationship. The authorization request typically includes the payment card account number, the amount of the transaction, and other information. The authorization request is routed via a payment card system 108 (which may be, for example, the well-known Banknet™ system operated by MasterCard International Incorporated, the assignee hereof) to the issuer financial institution (FI) 110 that issued the customer's payment card 102. Arrows 112, 114 and 116 trace the path of the authorization request from the POS terminal 104 to the issuer 110.

Assuming that all is in order, the issuer FI 110 transmits a favorable authorization response to the point of sale terminal 104 through the payment card system 108 and via the acquirer FI 106. (The path of the authorization response from the issuer FI 110 to the POS terminal 104 is traced by arrows 118, 120, 122.) The transaction at the point of sale terminal 104 is then completed and the customer leaves the store with the goods. A subsequent clearing transaction initiated by the merchant results in a transfer of the transaction amount from the customer's payment card account 124 to an account that belongs to the merchant. The customer's payment card account 124 may be, for example, either a debit card account or a credit card account. In the former case, the clearing transaction results in the funds being debited directly from the account 124. In the latter case, the clearing transaction results in a charge being posted against the account 124, and the charge subsequently appears on the customer's monthly credit card statement.

The foregoing description of the typical transaction may be considered to be somewhat simplified in some respects. For example, a merchant processing system (not shown) may be interposed between the POS terminal and the acquirer FI. As is familiar to those who are skilled in the art, a merchant processing system may be operated by or on behalf of the merchant to form part of the communications path between the acquirer FI and a considerable number of POS terminals operated by the merchant. It is also often the case that a third party transaction processing service, such as a payment services provider (PSP), may operate to handle payment card transactions on behalf of the acquirer and on behalf of a large number of other like financial institutions.

Many consumers currently carry two or more payment cards and/or store rewards cards and/or gift cards for making purchases. The payment card accounts may be sponsored by one or more issuer FIs, and can include credit card accounts, debit card accounts and/or pre-paid card accounts. Consumers carry multiple payment card accounts, rewards cards and/or gift cards to avoid carrying cash, to use to shop online, and/or to earn rewards (such as cash back, or points towards discounts on future purchases, or miles awards for use in obtaining discounts on future purchases of airline tickets). But consumers who carry multiple payment card accounts and/or rewards cards and/or gift cards can have a difficult time deciding which to use during a particular purchase transaction in order to obtain the maximum value, especially when it comes to maximizing rewards points or getting cash back. In particular, issuers of many payment card accounts and/or retailer rewards cards have rules and/or rewards offers that are changed periodically. For example, a particular rewards credit card account issuer may offer double points for gasoline purchases during the months of September, October, November and December, but starting January 1 the offer changes to one point for gasoline purchases and three points for grocery purchases during January, February, March and April. In addition, rewards card accounts and retailer card accounts may also have certain penalty fees attached to them. Moreover, many gift cards have an expiration date associated with the funds stored thereon, after which time the consumer can no longer use the gift card. Therefore, consumers who have multiple rewards payment card accounts and/or retailer or store rewards cards and/or gift cards may find it very difficult or nearly impossible to keep track of all of the various rules and/or rewards offers and/or benefits or penalties associated with their accounts. It follows that such consumers may find it very difficult or nearly impossible to keep track of all the combinations of rules and offers and benefits and penalties that would result in obtaining the maximum value (and/or of avoiding penalties or losing benefits). When this is coupled with the fact that many consumers carry a balance upon which they are charged monthly interest fees (and in some cases, also pay a yearly fee for the privilege of using certain payment card accounts), not being able to maximize rewards and/or cash back opportunities is a substantial problem for consumers.

The present inventors have recognized that there is a need for methods and/or systems to automatically determine and provide recommendations to a consumer concerning which of a plurality of various payment cards and/or rewards cards held by that consumer should be utilized for a particular purchase transaction to obtain the maximum value. Such systems and/or methods described herein are safe and simple to use, and function to help consumers avoid losing out on rewards and/or benefits and/or money due to payment account rules or restrictions and/or expiration dates. In addition, the present inventors recognized that the novel systems and/or techniques proposed herein present opportunities for novel value-added services which may be provided to consumers, merchants and/or financial institutions.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate exemplary embodiments and which are not necessarily drawn to scale, wherein:

FIG. 1 is a block diagram that illustrates a conventional payment system;

FIG. 2 is a block diagram that illustrates a transaction-handling system configured to operate in accordance with aspects of the present invention;

FIG. 3 is a block diagram illustrating an embodiment of the merchant device shown in FIG. 2;

FIG. 4 is a block diagram illustrating an embodiment of the customer mobile device shown in FIG. 2;

FIGS. 5A and 5B form a flowchart illustrating an intelligent advice process according to an embodiment of the invention;

FIG. 6 is a block diagram illustrating a smart preferences computer system according to an embodiment of the invention;

FIG. 7 is a screenshot of an example of a merchant checkout webpage that may be displayed to a consumer regarding a smart preferences process according to an embodiment of the invention;

FIG. 8 is a screen shot illustrating an example of a confirm details webpage associated with a smart preferences process according to an embodiment of the invention; and

FIG. 9 is a screen shot illustrating an example of a smart preferences account management webpage according to an embodiment of the invention.

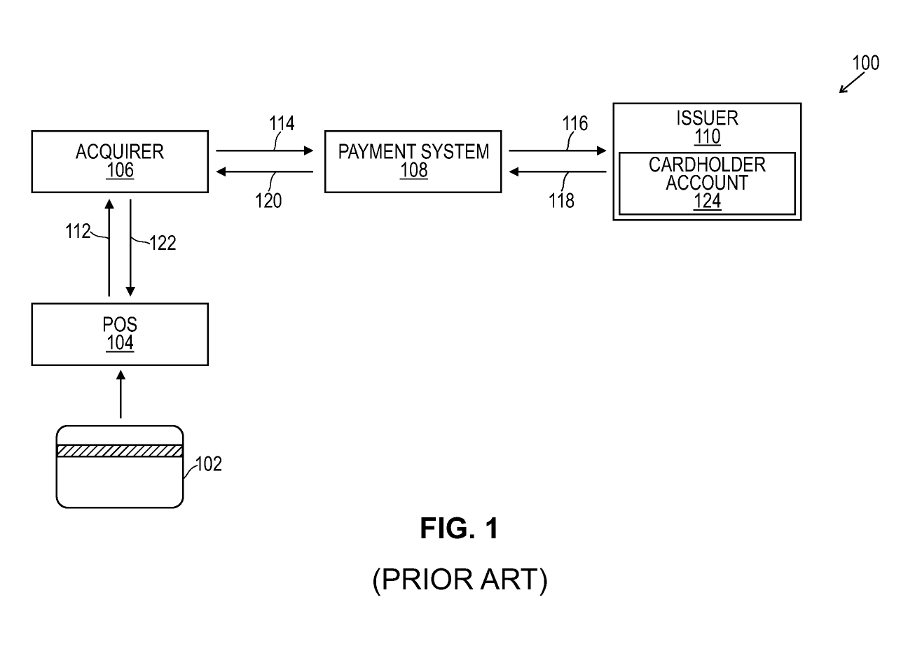

### DETAILED DESCRIPTION

In general, and for the purpose of introducing concepts of embodiments, described are methods and/or systems which provide recommendations to a consumer regarding which of a plurality of the consumer's various payment card accounts and/or rewards card accounts and/or gift cards should be utilized for a particular purchase transaction to obtain maximum consumer value. In some embodiments, the methods and/or systems function to automatically select an appropriate payment account and route payment account information to, for example, a merchant device for purchase transaction processing. In addition, the novel systems and/or techniques described herein present opportunities for including novel value-added services which may be provided to consumers, merchants and/or to financial institutions.

A number of terms will be used herein. The use of such terms are not intended to be limiting, but rather are used for convenience and ease of exposition. For example, as used herein, the term “cardholder” may be used interchangeably with the term “consumer” and are used herein to refer to a consumer, individual, business or other entity that has been issued (or authorized to use) a financial account such as a credit or debit account. The financial account may be accessed by use of a “payment card” or “payment device” such as a traditional plastic or embossed magnetic stripe card, a chip card (such as an EMV card) or an RFID card (such as a PayPass™ or MasterPass™ payment card). Pursuant to some embodiments, as used herein, the term “payment card” or “payment device” may also include a mobile device (such as a mobile telephone or table computer) operating a payment application that includes stored payment account information.

In some embodiments, a consumer who owns a payment enabled mobile device (such as a smartphone, a mobile telephone, a tablet computer, a laptop computer, a personal digital assistant (PDA) and the like) registers for a smart preferences service by providing information concerning the payment accounts (such as credit card accounts, debit card accounts, and/or gift card accounts) in his or her digital wallet to a smart preferences server computer system. When the registered consumer enters into a purchase transaction at a retail store, purchase transaction information may be transmitted from a merchant's device (such as a point of sale (POS) terminal) to the customer's mobile device for transmission to and use by a smart preferences server computer system. The purchase transaction information may include data such as an amount due for the purchase, a merchant identifier, and product identification details such as descriptions and/or identifiers for each item being purchased (and its associated purchase price). In other embodiments, the customer may manually input the transaction information into his or her mobile device for transmission. In some embodiments, the customer then operates his or her mobile device to initiate a request for a recommendation concerning which payment card account and/or rewards account and/or gift card available in his or her mobile wallet should be utilized to obtain the maximum value, while in other embodiments a request is not necessary because the recommendation(s) are provided automatically. The recommendation(s) may be at least partially based on the purchase transaction information and/or other information supplied by the consumer and/or other entities.

In some embodiments, the smart preferences server computer system includes a decision engine operable to determine one or more payment account recommendations for the consumer. The decision engine may utilize the purchase transaction information along with additional data to generate recommendations for the consumer to utilize for that particular purchase transaction. When two or more payment card accounts are recommended, they may be ranked in an order based on the preferences that were preselected by the consumer, or the payment account recommendations may be ranked in an order determined by the decision engine (which may be based on additional data). In some embodiments, the smart preferences server computer system transmits the recommendation(s) to the customer's mobile device for presentation to and selection by the consumer. The recommendation(s) may be presented, for example, via a display screen and/or audibly through a speaker of the consumer's mobile device. The consumer may then make a selection, for example by utilizing a touch screen on his or her mobile telephone, and then information regarding the selected payment account is then transmitted to a merchant device. Standard purchase transaction processing may then occur in order to consummate the purchase transaction. However, in some implementations, the decision engine not only makes a determination of a payment account to utilize but also automatically transmits the payment account information to the merchant device without requiring a selection or further input from the consumer. Thus, in this case, the consumer trusts the decision engine to make the best choice.

In some embodiments, a consumer registers for the smart preferences service by visiting a smart preferences website and providing requested data, or provides data in some other manner to the system. In some implementations, a smart preferences recommendation application program is downloaded and stored in a secure location on the consumer's mobile device (such as in a secure memory location of a smartphone). The smart preferences recommendation application is operable to analyze purchase transaction information and then, based on that data and data supplied by the consumer during registration, operate to provide one or more recommended payment card account options to the consumer (for example, by displaying the recommended payment accounts on a display screen of the consumer's mobile device). In an implementation, the consumer's mobile device periodically communicates with a smart preferences website server computer to download updated information, if required, and/or to download updates to the smart preferences application program. For example, if there are updates to benefits data and/or rewards data concerning one or more payment accounts in the consumer's digital wallet, these updates will be downloaded to that consumer's mobile device for use during future purchase transactions.

When the consumer selects one of the recommended payment card accounts for use in a purchase transaction, in an implementation the consumer's mobile device transmits the selected payment account to the merchant device for payment transaction processing. In an implementation, the merchant device transmits a purchase transaction request to the merchant's acquirer financial institution (FI), which contacts a payment network that indentifies the consumer's issuer financial institution (FI) and then forwards an authorization request for the purchase transaction to the issuer FI. If all is in order, the issuer FI authorizes a transfer of funds from that selected payment card account to the merchant's payment account in the acquirer FI. The vehicle for the funds transfer may therefore be a conventional payment transaction of the type now supported by at least one payment card system. Upon authorization and/or completion of the payment transaction, the acquirer FI may confirm to the merchant that the funds transfer has occurred (or is assured to occur subsequently during conventional clearing operations). In response to receiving the funds transfer confirmation, the merchant then transfers ownership of the goods to the consumer, or may accept the confirmation as payment for services rendered or to be rendered to the consumer. Is should be understood, however, that the processes described herein may utilize a conventional payment network, and/or the internet, and/or any other network and/or payment channel.

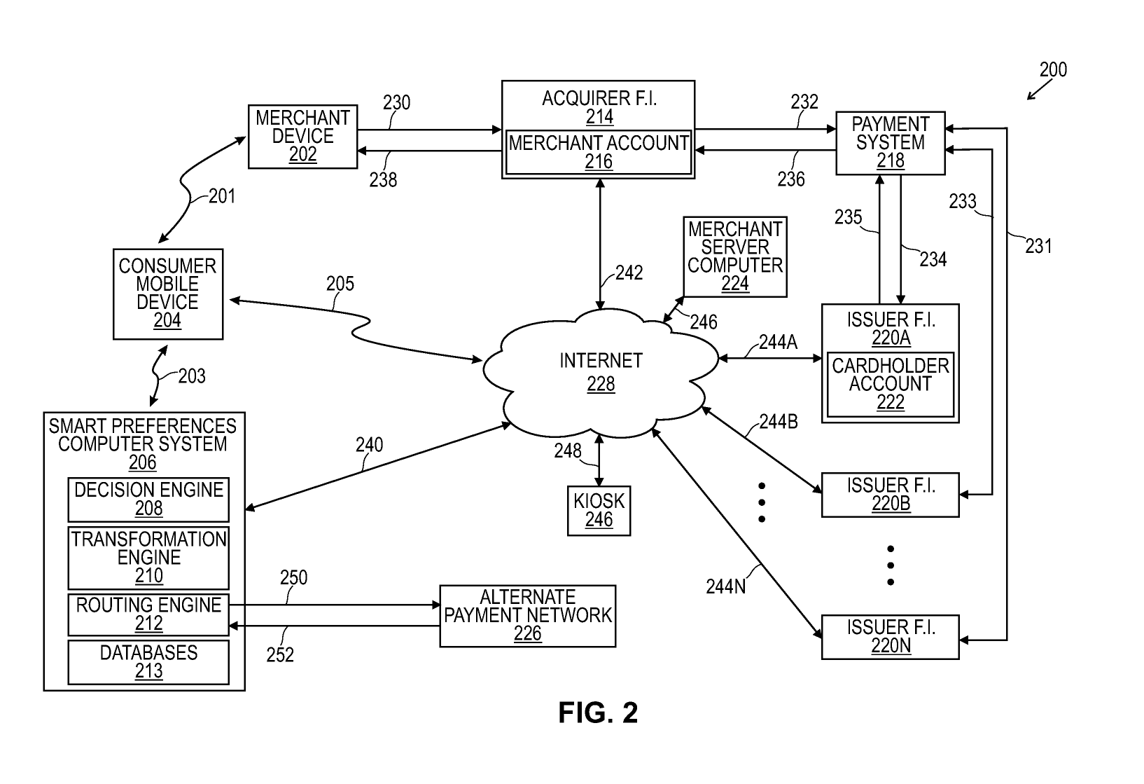

FIG. 2 is a block diagram of a transaction handling system 200 including components configured to operate in accordance with aspects of the processes described herein. It should be understood that the various components shown in FIG. 2 may be a subset of a larger system for providing payment card recommendations to consumers and for facilitating purchase transactions between consumers and merchants via credit card accounts, debit card accounts, reward card accounts, other types of financial accounts and the like, and/or for facilitating payment transactions between one or more financial institutions (FIs) such as acquirer and issuer banks. It should also be understood that, in some embodiments, consumers, Issuing financial institutions (FIs) and Acquirer FIs may be required to enroll or register with the smart preferences system (for example, via a website or webpage hosted by a smart preferences server computer system) before processing in accordance with embodiments described herein can occur.

The transaction handling system 200 includes a merchant device 202 which may be, for example, a POS terminal or a suitably programmed mobile telephone or personal digital assistant (PDA) with communication capabilities. If the merchant device is a POS terminal, such as a cash register in a retail store location, it may be configured to operate for the most part in a conventional manner, or it may have functionality that actively contributes to the transaction flow illustrated in FIG. 2. The POS terminal 202 may, for example, be found in any type of business establishment, and can be configured to transmit a merchant identifier, purchase transaction information, and other data to the consumer's or customer's mobile device 204. The consumer's mobile device may be a smartphone, a tablet computer, a laptop computer, a personal digital assistant (PDA), or some other mobile device capable of receiving and transmitting data as described herein. The transmitting of the transaction information from the merchant device 202 to the consumer's mobile device 204 may be via wireless communication such as NFC (near field communication) or can be via a mobile telephone network using text messaging, such as SMS or MMS messaging or the like.

As mentioned above, the consumer's mobile device 204 may be a payment-enabled mobile telephone capable of initiating payment transactions in a payment card system. Operation of a mobile telephone to initiate funds transfers via a payment card system is described, for example, in commonly assigned U.S. published application no. 2008/0249928, filed Aug. 10, 2007, entitled “Payment Card Based Remittance System with Designation of Recipient By Mobile Telephone Number”, which is incorporated herein by reference. In some implementations, the consumer's mobile device 204 is not payment-enabled but still can be configured to communicate with the smart preferences server computer system as described below. In some embodiments, the customer's mobile device may initiate a payment transaction by interacting with a website operated by a payment services provider (PSP) or by the issuer of the customer's payment card account.

Referring again to FIG. 2, the transaction handling system 200 includes a smart preferences server computer system 206, which in some embodiments includes a smart preferences decision engine 208, a smart preferences authentication request transformation engine 210, a smart preferences routing engine 212, and one or more databases 213. The smart preferences decision engine 208, smart preferences authentication request transformation engine 210, and smart preferences routing engine 212 may be separate computers or computer systems, or may be components of a single computer or computer system. The transaction handling system also includes an acquirer financial institution (FI) 214 that issued a merchant financial account 216 (which may be, for example, a payment card account), a payment system 218 (such as the Banknet™ system referred to above, for routing transactions, for example, from the issuer FI 220A to the acquirer FI 214), a plurality of issuer FI's 220A, 220B to 220N (which may represent banks, for example, that issued one or more cardholder accounts to the consumer, such as cardholder account 222), a merchant server computer 224, and an alternate payment network 226. It should also be understood that the various components depicted in FIG. 2 may be configured to communicate via the Internet 228. Also, some components may be configured for communications directly with other components, for example, the Issuer FI's 220A, 220B and 220N may be configured to communicate directly via wireless or wired connections 231, 233, 234 and 235 with the payment system 218. In addition, for ease of understanding, the transaction handling system 200 generally shows only components that are involved in handling one transaction, but in practice many more devices may be included, for example, the system may include a plurality of merchant devices 202, acquiring FIs 214, merchant server computers 224, and kiosks 246.

Arrow 201 represents wireless communications between the consumer mobile device 204 and the merchant device 202, arrow 203 represents wireless communications between the consumer mobile device 204 and the smart preferences computer system 206, and arrow 205 represents wireless communications between the consumer mobile device 204 and the Internet 228. In some embodiments, the arrows 201 and 203 trace the path of an implementation of a smart preferences payment card account recommendation process. In particular, as part of a purchase transaction, the merchant device 202 transmits 201 purchase transaction information that may include a merchant identifier, a transaction amount and product identification data to the consumer's mobile device 204. In response to receiving the transaction information, in an implementation the consumer's mobile device 204 transmits 203 a request for a payment card account recommendation to the smart preferences server computer system 206. The request for the payment card account recommendation includes the transaction information (merchant identifier, purchase transaction amount and product identification data), and the smart preferences decision engine 208 utilizes this transaction data (and in some cases, additional data) to determine one or more payment card accounts to recommend to the consumer for use in that particular purchase transaction, for example, to maximize value for the consumer. It should be understood, however, that maximizing value for a particular consumer may be based on preferences provided by that consumer that do not necessarily equate to saving the most money or earning the maximum number of points in a rewards system. For example, the consumer may value or perceive earning miles on a first payment card account as better than earning points on a second payment card account, even when the number of points for a specific purchase transaction has a money value greater than the money value of the miles to be earned on the first payment card account. This may be because, for example, that consumer is planning a vacation trip and wishes to use earned miles in the future to reduce the price of airline tickets.

Referring again to FIG. 2, in response to the request for a recommendation, the smart preferences computer system 206 then transmits 203 a payment card account recommendation to the consumer's mobile device 204 for display on a display screen (not shown) of the consumer's mobile device. In some embodiments, the consumer then utilizes a keypad or other input device (not shown) to select one of the recommended payment card accounts for use in that purchase transaction, which will be transmitted 201 to the merchant device 202 for further processing.

In FIG. 2, the arrows 230, 232, 234 trace the path of the purchase transaction after the consumer selects a payment card account to utilize. In this example, the decision engine 208 recommended a payment card account for use in the current purchase transaction that was issued by the issuer FI 220A. As explained above, the consumer selected that particular payment card account by using a keyboard or a touchscreen or other input means (not shown) on the customer's mobile device 204. The mobile device transmits information regarding that payment card account to the merchant device 202 which then transmits 230 a purchase authorization request to the merchant's acquirer FI 214. The merchant acquirer FI 214 transmits 232 the authorization request to the payment system 218, which identifies the issuer bank as the issuer FI 220A and then routes 234 the authorization request to the issuer FI 220A. If all is in order (i.e., the consumer has adequate credit to pay for the purchase), then the Issuer FI 220A transmits 235 an authorization response to the payment system 218 which routes 236 the authorization response to the acquirer FI 214 that may include authorization of a payment transfer from the consumer's cardholder account 222 to the merchant account 216. In some embodiments, the merchant's acquirer FI 214 then transmits 238 the authorization response to the merchant device 202 to inform the merchant that the purchase transaction has been authorized. When the merchant device 202 receives the confirmation message the merchant may allow the sale or other exchange of value to be completed. Such a purchase transaction process may be entirely conventional.

As shown in the transaction handling system 200, the smart preferences computer system 206 is configured to communicate 240 via the Internet 228 via a connection 242 with Acquirer FIs such as the Acquirer FI 214, via connections 244A, 244B and 244N with the Issuer FI's 220A, 220B to 220N, with a plurality of merchant server computers such as via the connection 246 to the Merchant Server computer 224, and with a plurality of consumer mobile devices such as the consumer mobile device 204 via the connection 205. For example, the smart preferences computer system may need to update one or more mobile recommendation applications resident in one or more consumer devices, and may utilize the Internet to push such updates to consumer devices that need it. In addition, the smart preferences computer system 206 may be configured to periodically request updated information from one or more Issuer FIs, Acquirer FIs and/or Merchant Server computers. Such updated information may include changes to rules and/or to benefits and/or to rewards associated with consumer payment accounts and/or merchant rewards cards accounts and/or gift card accounts being utilized by consumers.

In some embodiments, the smart preferences server computer system 206 is configured to communicate via connection 240 over the Internet with one or more Kiosks 246 via the connection 248. For example, if a consumer utilizes the Kiosk 246 to initiate a purchase transaction, and that consumer has a digital wallet account and is registered with the smart preferences system, then he or she may receive one or more payment account recommendations in the format and/or channel in which they prefer. For example, a consumer utilizing the Kiosk 246 may be provided with recommendations on a display screen (not shown) and/or audibly via a speaker (not shown) associated with the Kiosk. In some embodiments, the consumer may then be visually and/or audibly prompted to make a selection by using an input device such as a touch screen (not shown) associated with the Kiosk. After the consumer makes a payment account selection, purchase transaction processing proceeds as explained above.

In some implementations, the smart preferences computer system 206 is also configured to route payment authorization requests to an alternate payment network 226 (for example, a payment network operated by the American Express Company) when the need arises. For example, if the decision engine 208 recommends a payment card account for use in a particular purchase transaction that was not issued by any of the Issuer FIs 220A to 220N but was instead issued by an alternate Issuer FI (not shown) that is a member of the alternate payment network 226, and if the customer selects that payment card account, then the consumer mobile device 204 transmits 203 that selection back to the smart preferences server computer system 206 instead of to the merchant device 202. In this case, the authentication request transformation engine 210 and routing engine 212 operate to route an authorization request 250 to the alternate payment network 226 for processing, which will follow a normal transaction flow for that network. In some implementations, the routing engine charges a routing fee to an alternate Issuer FI (not shown) that is identified by the alternate payment network 226 during the normal transaction flow. Assuming all is in order, the smart preferences computer system 206 will then receive 252 an authorization response that will be transmitted 240, 242 via the Internet 228 to the merchant's Acquirer FI 214 for further processing. In some embodiments, the Acquirer FI 214 then transmits 238 the authorization response to the merchant device 202 to inform the merchant that the purchase transaction has been authorized. When the merchant device 202 receives the confirmation message then the merchant may allow the sale or other exchange of value to be completed. In some implementations, the consumer or cardholder may be unaware that such processing has occurred.

It should be understood that, in practice the transaction system 200 may include numerous Issuing FIs and a plurality of Acquirer FIs all connected to the payment system 218, many more alternate payment networks 226, a large number of merchant devices 202 and a very large number of customer mobile devices 204.

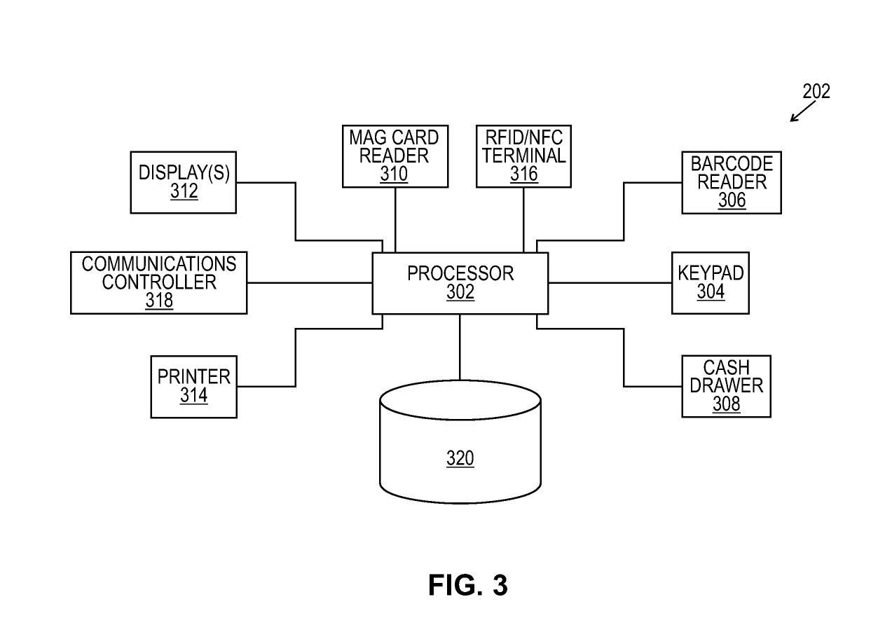

FIG. 3 is a block diagram of a POS terminal for serving (in some embodiments) as the merchant device 202 shown in FIG. 2. In some embodiments, the POS terminal 202 may be largely or entirely conventional in its hardware aspects. Nevertheless, the POS terminal may be programmed to provide functionality as described herein.

The POS terminal may include a processing element (or elements) such as the processor 302 shown in FIG. 3. The processor 302 may for example be a conventional microprocessor, and may operate to control the overall functioning of the POS terminal 202. The POS terminal may also include conventional peripheral components, in communication with and/or controlled by the processor 302. Such components may include a keypad 304 for receiving input from a human operator of the POS terminal, a barcode reader 306 for reading product barcodes from products brought to the terminal for purchase, a cash drawer 308 for storing cash received from customers, a magnetic stripe reader 310 for reading payment card account numbers and related information from magnetic stripe payment cards, one or more displays 312 for providing output (e.g., identifying products presented for purchase and their prices, indicating sales tax due, indicating transaction subtotals and totals, etc.), a printer 314 for printing out sales receipts, a wireless communication terminal/proximity reader 316 for exchanging wireless short range communications/near field communications (NFC) with the consumer's mobile device such as a smartphone equipped with contactless payment device capabilities, and a communication controller 318 for allowing the processor 302, and hence the POS terminal 202, to engage in communication over data networks with other devices such as a merchant processing system (not shown) or an acquirer FI computer 214 (shown in FIG. 2). In some embodiments, at least one of the displays 312 may be a touch screen, so as to provide an input function as well as an output function. In some embodiments, the communication controller, or another communication device coupled to the processor 302, may be provided to allow the POS terminal 202 to transmit and receive text messages or the like via a mobile telephone network (not shown). In addition, the POS terminal 202 may include one or more memory and/or data storage devices (indicated collectively at 320), which may comprise any combination of one or more of a hard disk drive, RAM (random access memory), ROM (read only memory), flash memory, and the like. The memory and/or data storage device(s) 320 may store software and/or firmware that programs or instructs the processor 302 and thus the POS terminal 202 to perform functions and/or include functionality and/or operate as described herein. Further, the POS terminal 202 may include one or more housings (not shown) which contain and/or support one or more of the other components shown in FIG. 3. One skilled in the art will recognize that components such as the magnetic card reader 310 and/or the RFID/NFC terminal 316 may be integrated in a single unit, and may include a display and/or touch screen to allow for user interaction (for example, input from a cashier).

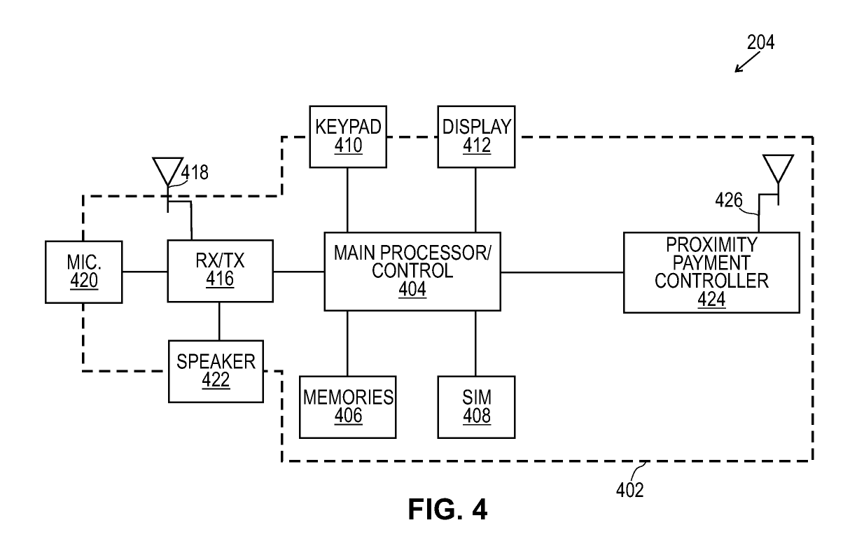

FIG. 4 is a block diagram illustrating the components of a consumer's mobile device 204 (shown in FIG. 2). In an embodiment, the consumer mobile device is a mobile telephone that may (but need not) have capabilities for functioning as a contactless payment device. In its hardware aspects the mobile telephone 204 may be entirely conventional, and indeed in some of its software aspects it also may be conventional, and may provide novel functionality as described herein through interaction (via a conventional browser) with a web page that supports initiation of purchase transactions. In other embodiments, however, novel functionality as described herein may result at least partially from software and/or firmware that programs or instructs one or more processors of the mobile telephone 204.

The mobile telephone 204 may include a conventional housing (indicated by dashed line 402) that contains and/or supports the other components of the mobile telephone 204. The mobile telephone 204 further includes conventional control circuitry 404, for controlling over-all operation of the mobile telephone 402. Preferably the control circuitry 404 is suitably programmed to allow the mobile telephone 204 to engage in data communications and/or text messaging with other wireless devices and/or electronic devices, and to allow for interaction with web pages accessed via browser software, which is not separately shown. Other components of the mobile telephone 204, which are in communication with and/or are controlled by the control circuitry 404, include one or more memory devices 406 (e.g., program and working memory, etc.), a conventional subscriber identification module (SIM) card 408, a conventional keypad 410 (or touch screen) for receiving user input, and a conventional display 412 (or a touch screen) for displaying output information to the user.

The mobile telephone 204 also includes conventional receive/transmit circuitry 416 that is also in communication with and/or controlled by the control circuitry 404. The receive/transmit circuitry 416 is coupled to an antenna 418 and provides the communication channel(s) by which the mobile telephone 204 communicates via the mobile network (not shown). The mobile telephone 204 further includes a conventional microphone 420, coupled to the receive/transmit circuitry 416. Of course, the microphone 420 is for receiving voice input from the user. In addition, a loudspeaker 422 is included to provide sound output to the user, and is coupled to the receive/transmit circuitry 416.

The mobile telephone 204 may also include an integrated circuit (IC) or chipset 424 or proximity payment controller of the kind embedded in contactless payment cards. For example, the IC 424 is connected to an antenna 426 and operates so as to interact with an RFID/NFC proximity reader of a POS terminal to provide a payment card account number for a purchase transaction at the POS terminal. For example, the IC 424 may be designed and/or programmed to operate in accordance with the well-known PayPass™ or MasterPass™ standard (promulgated by the assignee hereof) for contactless payment applications.

As mentioned above, the consumer's mobile device may be configured and/or programmed to operate in accordance with the PayPass™ and/or MasterPass™ standard, so that the mobile device can be utilized to make payments. In particular, the mobile MasterCard® MasterPass™ system and processes are based on industry standards for contactless payments and consists of a MasterPass™ contactless payment application running on a secure chip in a customer's mobile telephone. Consumers or cardholders who use MasterPass™ get through checkout lines faster because sales clerks don't have to deal with cash or cards, and such consumers have the flexibility to spend whatever they want instead of being limited to the cash they have in their pocket. In addition, the MasterPass™ architecture provides integration with and/or access to other services, such as the smart preferences service. In particular, in some implementations a consumer who has already registered to utilize MasterPass™ can easily register to utilize the smart preferences system. For example, in some embodiments when the consumer utilizes MasterPass™ to make a purchase at a Merchant website or a retail store, if that consumer has not used the smart preferences system, a prompt is provided on the display screen of the consumer's mobile device that asks the consumer if he or she would like to register for the smart preferences service. If the consumer indicates an interest, the consumer may be redirected to a secure smart preferences website and prompted to provide information concerning his or her payment card accounts and one or more preferences into input fields on one or more smart preferences web pages. In some implementations, the consumer may access the smart preferences website through a merchant device, a kiosk, a laptop computer, a desktop computer, or other digital device. In some embodiments, the secure smart preferences website and/or the smart preferences system is operated by MasterCard International Incorporated or an associate or affiliate thereof for the purposes of registering consumers and/or merchants and/or issuing banks and/or acquirer banks for the smart preferences service.

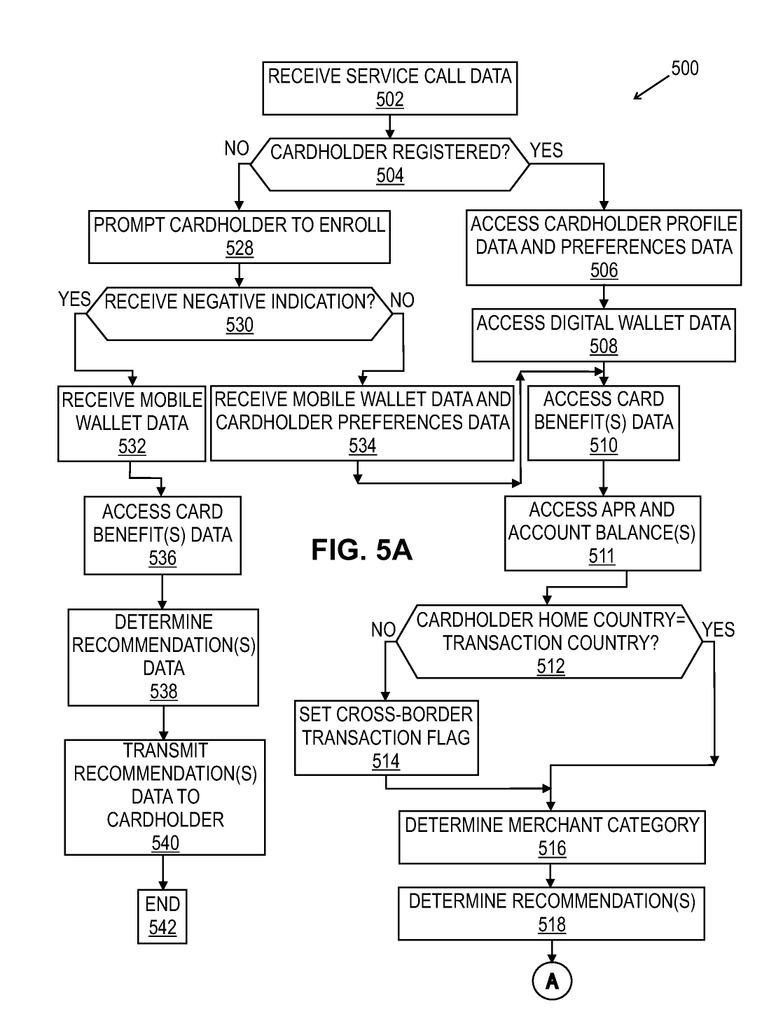

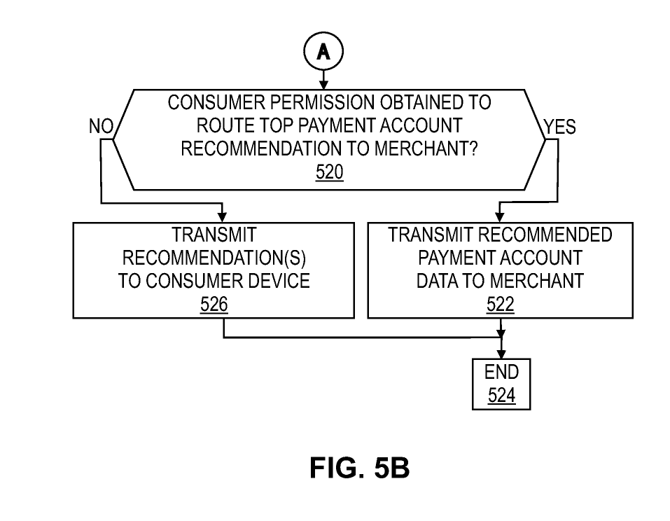

FIGS. 5A and 5B form a flowchart 500 that illustrates an intelligent advice process provided by a smart preferences computer system according to some embodiments. In particular, a consumer having a mobile wallet initiates a purchase transaction, for example, at a POS terminal located at a merchant retail store, or via a merchant's Internet website, or via a Kiosk in a shopping mall, and the like. When the cardholder initiates the purchase transaction, he or she may indicate a desire to utilize the smart preferences system (for example, by clicking on a “smart preferences” radio button on the merchant's checkout Webpage) which causes service call data to be received 502 by the smart preferences server computer. The service call data may be received, for example, from a merchant's Website purchase transaction check-out page, from a mobile device of the consumer, from a merchant device such as a POS terminal, or from a Kiosk. The service call data may include, for example, consumer data, merchant data, location data and purchase transaction data associated with the purchase transaction. In some embodiments, the purchase transaction data includes line item information that identifies each individual product and/or service being purchased, each item price and/or service price, and a total purchase amount. In addition, the service call data may include communications data (such as a mobile telephone number) that can be used by the smart preferences server computer to transmit recommendation data to the cardholder device or other device (such as a POS terminal or Kiosk) being utilized by the cardholder to purchase the goods and/or services.

Referring again to FIG. 5A, if it is determined in step 504 that the cardholder is a registered user of the smart preferences system, then the smart preferences computer system accesses 506 the cardholder profile data, which may include cardholder preferences data, and which may be stored in one or more databases. Next, the smart preferences computer accesses 508 digital wallet data, which may be stored in a digital wallet database, and extracts data regarding the cardholder's card products. For example, data concerning the issuing FIs for each cardholder card product and the cardholder's home country may be obtained. The smart preferences computer may then operate to access 510 card benefits data, which may be in a payment card database, and may include data such as rewards and/or rebate information associated with one or more of the cardholder's payment card accounts, and/or rules or requirements associated with obtaining such rewards and/or rebates to apply to the present purchase transaction, and/or expiration dates associated with rewards and/or rebates and the like. The smart preferences computer also accesses 511 the annual percentage rate (APR) data for each of the cardholder's payment card accounts, and may also obtain current balance data (if there is a balance) for each or those payment card accounts. Such data may be obtained from, for example, each issuer FI associated with the cardholder's payment card accounts.

Next, the cardholder's home country is compared 512 to the country in which the purchase transaction is occurring. If the current purchase transaction is in a country different than the cardholder's home country, then the decision engine sets 514 a cross border transaction flag, and the process continues with step 516. (The cross border flag may be utilized during recommendation processing to help determine, for example, which payment card accounts should be ruled out from being recommended because certain payment card accounts impose foreign transaction fees for foreign purchase transactions.) If, in step 512 the current purchase transaction is in the same country as the cardholder's home country then the process continues directly with step 516. In step 516, the smart preferences computer system determines a merchant category for the merchant involved in the purchase transaction, and the merchant category data may be utilized as a data input when determining which payment card accounts to recommend.

The smart preference computer system next determines 518 recommendations based on the cardholder's profile data, benefits data, the APRs associated with each payment card account, and the cardholder's payment card account balances (if any). The recommended payment card accounts may be ranked in accordance with the consumer's preferences, but in some cases one or more consumer preferences may be overruled by the decision engine. For example, the cardholder may have indicated a preference for using his or her American Express® Platinum Delta SkyMiles™ Credit Card for all online purchases. However, the decision engine may determine that for a current online transaction, that American Express® Platinum Delta SkyMiles™ account has a high balance (for example, a balance of $3,000.00 or more) and that card account carries a relatively high APR when compared to other payment card accounts in the cardholder's electronic wallet. Thus, the decision engine of the smart preferences computer system may instead recommend one or more of the other payment card accounts of the cardholder that excludes the preferred payment card account for that reason. The decision engine may also take other characteristics into consideration, such as payment card account benefits and/or service call data and/or foreign data associated with the cardholder and/or with the purchase transaction. In some embodiments, some of these different types of data may be weighted, either by the cardholder or by the decision engine, so that some types of data carry more weight than others during the decision process. The decision engine may utilize a point system to rank the cardholder's payment card accounts with regard to the data concerning a particular transaction, such that only the top two or three cardholder accounts (with the highest scores) are presented to the cardholder for consideration. In some embodiments, points may be deducted from the overall score of a particular payment card based on one or more issues that are detrimental to the cardholder, such as a high APR or large credit balance due. A threshold value or a different ranking factor may also be set that is utilized to disqualify one or more payment card accounts from being recommended.

Referring now to FIG. 5B, the smart preferences computer system next determines 520 if the registered cardholder provided permission to route the top payment card account recommendation (the best choice as determined by the decision engine) directly to the merchant to consummate the purchase transaction. If so, then the recommended payment card account data (as determined by the decision engine of the smart preferences computer system) is routed or transmitted 522 directly to the merchant device, for example, via the consumer's mobile device or via the Internet, to consummate the purchase transaction. In such a case, an indication of the recommended payment card account may also be transmitted for display, for example, on the cardholder's device so that the consumer knows which payment card account was utilized for that purchase transaction. The smart preferences payment card account recommendation process then ends 524.

However, if in step 520 the consumer did not provide permission to the smart preferences computer system to automatically route the best choice payment card account data to the merchant, then the payment card product recommendation(s) are transmitted 526, for example, to the cardholder's mobile device for display on a display screen. The recommendation(s) may also be transmitted, for example, for display on a display screen of a POS terminal or Kiosk, or for display on a display screen of a tablet computer, and the like. Several payment card account choices may be provided, and these may be presented in an order from the best choice at the top (or first) to the next best choice (or second), and so forth. In some implementations, cardholders may specify a preference to receive only the top two choices as determined by the decision engine for display in order to make a selection. The consumer would then be responsible for selecting an appropriate payment card account to utilize for the particular purchase transaction and to transmit that selection to the merchant, for example, from the cardholder's smart phone to a merchant device (such as a POS terminal). Thus, after the recommendations are transmitted to the cardholder, the smart preferences payment card account recommendation process ends 524.

Referring again to step 504 of FIG. 5A, if the service call data is not associated with a registered cardholder, then the smart preference computer system prompts 528 the cardholder to enroll with the smart preference system. In some embodiments, the smart preference computer system transmits a message requesting that the consumer register for a smart preferences wallet account by providing information concerning all of the payment card accounts and/or gift cards and/or retailer rewards cards held by his or her household. For example, such a request may be transmitted to a POS terminal, or to the consumer's mobile device, or to a Kiosk. In particular examples, the consumer may be prompted to enter required information into a smart preferences application loaded onto the consumer's mobile device, or to enter the information into a menu provided on a Webpage of a merchant's Website, or to provide the information to a merchant representative for entry into an application provided on a POS terminal or other merchant device. However, in some cases, for example if the cardholder is in line at a retail store and does not wish to register, then the smart preference computer system receives 530 a negative indication. In this case, in some embodiments the smart preferences server computer receives limited information, such as the cardholder's mobile wallet data 532 which identifies the payment card account products that the cardholder has in his or her digital wallet. (It should be understood that the digital wall data may be an incomplete list of the cardholder's payment card accounts, and thus may not include, for example, other accounts such as one or more gift card accounts and the like owned by the consumer). The smart preferences server computer next accesses 536 card benefit(s) data. The payment card benefits data may be obtained from, for example, a card benefits database and may be based on the information from the cardholder's mobile wallet. The decision engine next determines 538 payment card account recommendation data and transmits 540 the recommendation data to the cardholder, and the smart preferences payment card account recommendation process then ends 524. It should be understood, however, that the recommendation(s) made in this manner may not be optimal for the cardholder, as the decision engine does not have full data (and in fact may have minimal and/or incomplete data) upon which to recommend one or more payment card account(s) may be based on (for example, because consumer preference data is lacking) in contrast to the recommendations that can be made for a registered cardholder.

In some embodiments, the recommendation data may be transmitted, for example, to the cardholder's smartphone and processed to display indications of one or more recommended payment card account(s) on a touch screen. In an implementation, the cardholder then touches an icon representing one of the recommended payment card accounts to transmit cardholder data of that payment card account to the merchant device to consummate the purchase transaction.

Referring again to FIG. 5A, if in step 530 the smart preference computer system does not receive a negative indication (that is, a positive indication is received instead that indicates that the cardholder wishes to register, which may simply be indicated by the smart preferences payment services computer system receiving requested data), then the smart preferences computer system receives 534 the mobile wallet data of the cardholder along with cardholder preferences data. The process then continues with step 510 onward, as explained above. In this case, the payment card account recommendation(s) will be made, as explained above, based on the service call data, cardholder profile data, cardholder preference(s) data, digital wallet data, APR data, card account balances data, and/or other data. The recommendations would then be routed either directly to a merchant device, or may be transmitted to a cardholder device so that the consumer can review the recommendation(s) and select a payment account to utilize for the purchase transaction.

It should be understood that a consumer may enroll or register with the smart preferences system in any of a number of ways, including by accessing a smart preferences server computer via the Internet and providing required information. During smart preferences cardholder registration, a consumer may provide basic information about himself or herself and, in some embodiments, the customer's mobile device (for example, by providing a SIM identifier and/or a mobile telephone number and/or other device identifier). The consumer also provides information concerning one or more bank credit card accounts, debit card accounts and/or gift cards issued to him, which may be designated as a first digital wallet. The consumer may also provide information about the credit and/or debit card accounts and/or gift cards issued to one or more family members, such as his wife or children, which may be designated as a second digital wallet. The first and second digital wallets together may form a “Household Wallet” account. The smart preferences decision engine of the smart preference computer system may then be operable to analyze all of the accounts in the Household Wallet to provide one or more recommended payment card accounts for use in a particular purchase transaction entered into by either of the husband or the wife.

In addition, during the smart preferences registration process the cardholder may also be prompted to provide information concerning preferences for earning rewards or benefits, for example, a desire to increase cash back or to earn more air miles instead of receiving rewards points. In an implementation, the consumer may indicate the relative importance of his or her preferences by ranking the preferences in an order of importance or by providing a weighting to each category. Examples of preferences may include utilizing any particular payment card account to earn travel miles, to earn more discounts, and/or to have no liability or better product protection (for example, an extended warranty for electronic merchandise), or the cardholder/consumer may indicate that he or she has no specific preference(s). In some embodiments, the cardholder may access and utilize a smart preferences website (not shown) to register for the smart preferences digital wallet service, or may be prompted to register for the smart preferences service when checking out at a merchant website. In some implementations, the consumer may be able to register for the smart preferences wallet by utilizing his or her mobile device, such as a smartphone.

In some embodiments, during the registration process the cardholder may indicate that he or she desires the smart preference computer system to automatically determine the best payment card account to utilize for each purchase transaction, and to transmit that choice directly to the merchant to consummate the purchase transaction. For example, if the cardholder is utilizing his or her payment enabled smartphone to pay for merchandise at a retail store of “Merchant A”, the smart preference computer system may automatically determine that the cardholder's “Merchant A Rewards” credit card is the best choice and transmit that choice to the POS terminal in Merchant A's store. In some embodiments, a message may appear on the display screen of the cardholder's smartphone informing the cardholder of the selected payment card account, and/or a text message may be transmitted to the smartphone, and/or an audible message may be played to the cardholder. In some implementations, the cardholder pre-selects how and when he or she is notified when the smart preference computer system selects and transmits the payment card account information for a particular purchase transaction to the merchant.

In some embodiments, upon receiving purchase transaction data associated with a registered cardholder, the smart preferences server computer system transmits the payment card account recommendations directly to the cardholder's device, such as the cardholder's mobile telephone, wherein the recommendations may be are audibly presented to the cardholder. For example, if it is determined that the consumer should utilize the “BigBank MasterCard® Rewards” card to pay for a new flat screen television, but that a good second choice is to use the “BigBox Store MasterCard® Rewards” card, which are both in the cardholder's smart preferences wallet account, then instructions may be transmitted to the cardholder's smartphone to cause a speaker integrated within the cardholder's smartphone to announce: “Use of the “BigBank MasterCard® Rewards” card to pay for a new flat screen television is recommended because it would earn you $15 cash back on your next statement. However, a good second choice is to use the “BigBox Store MasterCard® Rewards” card because you would then earn 500 rewards points toward your next purchase. Please make a selection.” In some implementations, the cardholder could audibly reply into the microphone of the smartphone: “Select “BigBank MasterCard® Rewards card” and the smartphone would then transmit that selection to the merchant's device. In some embodiments, the cardholder may also be presented with the choices on a touch screen display of his or her smartphone, and may instead make a selection by touching an icon representing the desired payment card account. Other choices in the cardholder's digital wallet may also be available for selection.

Factors that may play a role in the decision engine of the smart preferences system determining which payment account product to recommend to a particular consumer/cardholder can include that consumer's goals and/or priorities, benefits associated with one or more payment card or financial accounts of the consumer, crowd intelligence data and/or derived intelligence data. In addition, other factors, such as the merchant name, merchant transaction category, merchant affiliations, transaction time, transaction channel, transaction location, transaction history, payment card restrictions, payment card balances, and payment card maintenance fees, may also be considered when determining which payment card(s) to recommend to the cardholder. For example, when a consumer/cardholder registers or enrolls in the smart preferences service, the consumer may specify that his or her goals and/or priorities include sub-factors such as increasing cash back, earning air miles, having zero liability or better warranty protection when making purchases, travel benefits and/or receiving rebates and/or receiving discounts. The consumer may rank these priorities in an order from most important to least important, and thus in some embodiments may be prompted to assign a weight to each selected category during enrollment or registration. In some embodiments, the consumer can change his or her preferences and/or goals whenever he or she desires by logging into a website, for example, and providing identification and login information. Payment card account benefits may include such sub-factors as standard benefits (like extended warranties, lowest price protection and baggage delay insurance provided by some card account issuers), Issuer-specific FI benefits and/or merchant-specific benefits. Crowd intelligence may be gathered from various sources such as social media websites (for example, facebook, twitter, myspace, pinterest, google+ and the like), RSS feeds, news sources, and a smart preferences user crowd (that may be defined to include cardholders with similar benefit profiles, and/or similar demographics, and/or similar socio-economic status). In addition, data including the merchant name, merchant transaction category, merchant affiliations, transaction time, transaction channel, transaction location, transaction history, payment card restrictions, payment card balances, and payment card maintenance fees can be considered along with crowd intelligence data and/or social media data to analyze that particular cardholders various payment card accounts, and then to provide a recommendation as to which payment card account(s) should be used by a consumer for a particular purchase in order to maximize value to the cardholder. Data such as facebook tags, re-tweets of information, or re-pinning of items in pinterest, may be utilized or aggregated to support a recommendation decision. In general, data concerning any consumer interactions, whether or not it occurs on the Internet, may be utilized by the smart preference computer system to help support a payment card account recommendation for a particular cardholder.

Derived intelligence data may also be utilized in the process of determining which cardholder card account product to recommend. The derived intelligence data may include the merchant name and/or merchant category, the country of origin of the transaction, the merchant location, the gender of the cardholder, and/or the segment to which the cardholder belongs (for example, the cardholder may have been categorized, for example, as belonging to one or more segments characterized as being affluent, mass market, urban, youth, early adopter, and the like). Each time a consumer/cardholder utilizes the smart preferences system to select a card product to utilize for a transaction, data about that transaction (including the selected payment card account) may be stored in a smart preferences log (in a database, for example). Thus, the smart preferences log may include data concerning transaction data such as the merchant name and location, the amount of the purchase, the date and time of the transaction, the merchant category, whether or not it was a cross border transaction, the card holder location, the currency used and/or interchange rate, the recommended card product(s), the selection made by the cardholder (whether or not a recommendation was followed), and the cardholder segment. The cardholder log may then be accessed by the smart preferences decision engine to modify one or more weightings associated with one or more sub-factors of the cardholder to make improved subsequent recommendations concerning future purchase transactions for that cardholder and perhaps for other cardholders in the same category or cardholder segment. Thus, the decision engine card product recommendation process may include self-learning, which in some embodiments occurs by analyzing historical transactions of consumers and/or cardholders, historic smart preferences decision engine recommendations with relation to selections made by cardholders, and aggregated intelligence data (for example, by analyzing electronic wallet consideration data and/or purchase transaction data). For example, the self-learning process may result in the realization the majority of cardholders belonging to a specific category prefer utilizing the “BigBox Store MasterCard® Rewards” when shopping online at the BigBox Store website, but those cardholders prefer using a “Visa® Rewards” card when shopping at a BigBox retail store location. Thus, a trend or an affinity regarding selection of a particular type of payment card account under certain circumstances that is detected by the smart preference computer system can be utilized to affect the rankings of various payment card accounts to result in making better and quicker future recommendations for cardholders.

The smart preferences decision engine is thus powered by a mapping process that utilizes the payment preferences of each registered consumer along with the benefits associated with all of the payment cards in a consumer's digital wallet while negating any known constraints on the payment cards. For example, if a cross-border purchase transaction is taking place, in some implementations the smart preference decision engine will disregard all payment card accounts in the cardholder's electronic wallet that charge an extra fee for such purchase transactions in favor of payment card accounts that do not charge such cross-border fees. In another example, even if the cardholder expressed a preference for using a merchant's rewards card account when shopping in that merchant's store, if the smart preference decision engine detects a gift card of the cardholder that is close to expiring, then a recommendation of payment accounts to select may list that gift card above that of the merchant's rewards card with an explanation concerning the expiration date. Cardholders can therefore trust the smart preferences decision engine of the smart preference computer system to provide the best “top of wallet” decision for consideration in order to maximize benefits and/or preserve benefits or rewards. In addition, the smart preferences computer system may be configured, as explained above with regard to FIG. 2, to route authorization requests to other or alternate payment networks (for example, to networks other than the MasterCard® payment network or the Banknet™ network), but in these circumstances, a routing fee could be charged to the alternate payment network operator.

In some embodiments, Issuer FIs or issuer banks and/or Acquirer FIs and/or merchants can also register with the smart preference system. Each of these entities may provide benefits information and/or rewards information (which may be stored in a benefits database) and one or more rules and/or limitations concerning one or more of the payment card accounts and/or restrictions or limitations on rewards and/or benefits offered to consumers. Information can include, but not be limited to, the amount of points or cash back rewards that can be earned for purchasing certain types of goods or services, and/or for purchasing a certain dollar amount of goods or services from particular merchants, the expiration date(s) for obtaining particular rewards or benefits, and/or rules that may govern obtaining certain rewards or benefits such as limits on the total amount of rewards that can be obtained. In this manner, consumers can earn standard benefits that are offered by payment card account entities such as MasterCard®, VISA® and American Express®, can earn additional issuer benefits or rewards (typically added-on by Issuer FIs such as banks), and/or can earn merchant benefits (for example, exclusive benefits offered by a particular merchant, such as a low price-match guarantee). In some embodiments, the benefits information and/or rewards information may be stored in one or more databases.

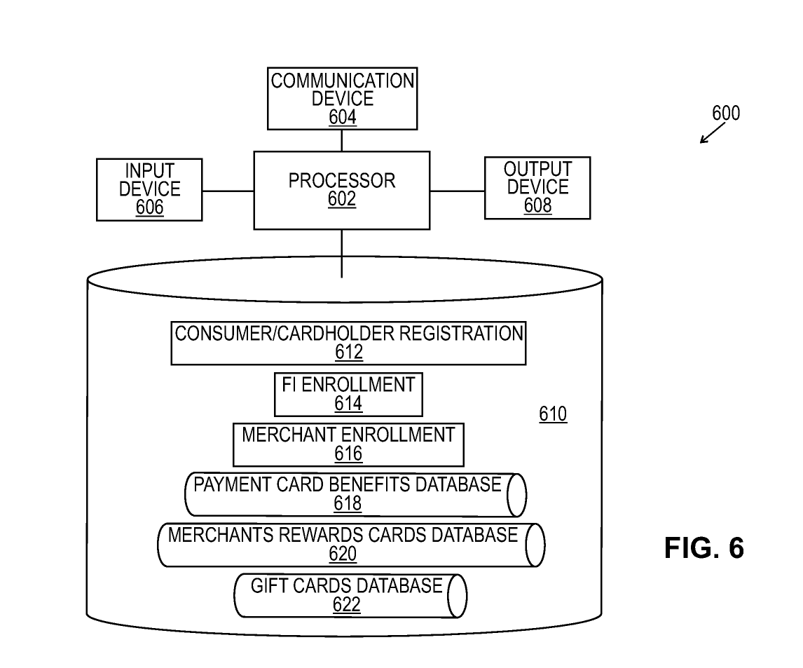

FIG. 6 is a block diagram illustrating a smart preference computer 600 according to an embodiment. A computer processor 602 is operatively coupled to a communication device 604, an input device 606, an output device 608, and a storage device 610.

The computer processor 602 may be constituted by one or more conventional processors. Processor 602 operates to execute processor-executable steps, contained in program instructions described below, so as to control the smart preferences computer 600 to provide desired functionality.

Communication device 604 may be used to facilitate communication with, for example, other devices (such as consumer mobile devices 204, merchant devices 202, Kiosks 246, cardholder Issuer FI computers 220, merchant server computers 224, and/or merchant Acquirer FI computers 214, as shown in FIG. 2). Communication device 604 may, for example, have capabilities for sending and receiving messages over mobile telephone networks, via the Internet, and/or engaging in data communication over conventional computer-to-computer data networks.

Input device 606 may comprise one or more of any type of peripheral device typically used to input data into a computer. For example, the input device 606 may include a keyboard and a mouse. Output device 608 may comprise, for example, a display and/or a printer.

Storage device 610 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as flash memory. Thus, the storage device 610 is a non-transitory computer readable medium and/or any form of computer readable media capable of storing computer instructions and/or application programs and/or data. It should be understood that non-transitory computer-readable media comprise all computer-readable media, with the sole exception being a transitory, propagating signal.

Storage device 610 stores one or more programs or applications for controlling the processor 602. The programs comprise program instructions that contain processor-executable process steps of the smart preferences decision engine computer 600, including, in some cases, process steps that constitute processes provided in accordance with principles of the present invention, as described in more detail below.

The programs stored by the storage device may include a cardholder registration application 612 that manages a process by which consumers or customers (i.e., cardholders) may register or enroll themselves and/or their mobile devices with the smart preferences computer 600. In some embodiments, the cardholder enrollment process may allow the cardholders to enroll themselves by accessing, via their mobile devices 204, a suitable web page hosted by the smart preferences computer 600. The information obtained from the cardholder during the enrollment process may include one or more payment card account numbers, one or more mobile telephone numbers (or other mobile identifiers), preference data and/or other information concerning the cardholder's payment card accounts. The enrollment process may also require the cardholder to select a PIN (personal identification number) to be used for security purposes in connection with purchase transactions to be initiated by the cardholder via his/her mobile telephone, and/or for use by a consumer to login and change one or more preference settings, for example. Other security measures may also be put in place, including industry-standard cardholder security processes and/or procedures. The smart preferences computer system may cooperate with the cardholder's issuing FI to implement security measures that assure that the individual enrolling with, or otherwise accessing, the smart preferences decision engine computer 600 is not an impostor.

The storage device 610 may also store an application 614 for managing enrollment of financial institutions (FIs) with the smart preferences computer 600. In some embodiments, actual enrollment of FIs with the smart preferences computer system may be performed by data entry or file downloads managed by an administrative employee of the entity that operates the smart preferences computer 600. This may occur after person-to-person contacts between an employee of the operator of the smart preferences computer system and an employee of the FI that is seeking enrollment. The FI may be enrolled as a cardholder issuer, a merchant issuer, or both. In some embodiments, the FI, as part of its enrollment process, may also enroll its cardholder account holders (consumers and/or merchants) en masse with the smart preferences computer 600. Further, after enrollment, a FI may be configured to, from time to time, feed to the smart preferences computer 600 enrollment data concerning newly acquired consumers and/or merchants now holding financial accounts issued by that FI. In addition, the smart preferences computer 600 may communicate and cooperate with FIs, such as Issuer FIs, to obtain rewards data and/or rebate data associated with the various payment card products offered to their customers or cardholders.

The storage device 610 may also store a merchant enrollment application 616. Merchants may enroll with the smart preferences computer 600 by providing information concerning, for example, merchant store value card accounts that, for example, provide discounts and/or rebates and/or other special incentives or benefits to consumers who shop in their retail stores or online at their merchant websites. Some of the incentives may involve loyalty points and/or discounts and/or other types of rewards for purchasing items from that merchant while utilizing the merchant store value card.

In addition, the storage device 610 may store one or more databases that are maintained by the smart preferences computer 600. Among these databases may be a payment card account benefits database 618, a merchants rewards cards database 620, and a gift cards database 622. The smart preferences computer 600 may be operable to obtain data to populate such databases directly from participating FIs and/or participating merchants regarding their rewards and/or rebates programs, including details concerning how points and/or rebates are awarded, rules governing how such points and/or rebates can be redeemed, and any limitations or restrictions placed on consumers and/or the cardholders' payment card accounts regarding such awards and/or rebates.

The application programs of the smart preferences computer 600 may be combined in some embodiments, as convenient, into one, two or more application programs. Moreover, the storage device 610 may store other programs, such as one or more operating systems, device drivers, database management software, web hosting software, and the like.

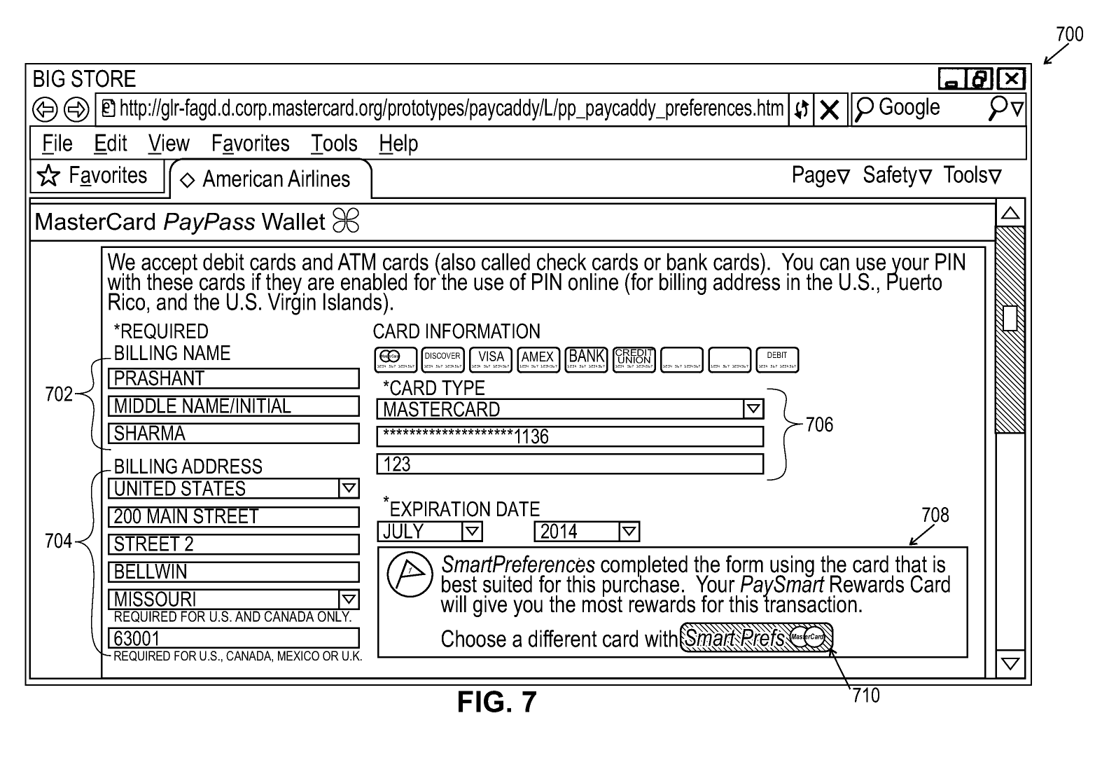

FIG. 7 is a screenshot 700 of an example of a Windows Internet Explorer “Big Store” checkout webpage that may be presented to a cardholder with respect to a smart preferences process in accordance with an embodiment. For example, the cardholder is in the process of purchasing items over the Internet from the “Big Store” online store using a personal computer or the like, and has entered his or her billing name 702 and billing address 704 in the provided entry boxes or fields. In addition, in this example, the consumer has already registered for the smart preferences service and thus a recommended payment card account (a MasterCard® credit card) including the credit card number and expiration date has been automatically populated in the “Card Information” section 706. (The smart preference computer system has automatically selected a payment card account and populated the form in accordance with the cardholder's wishes where the consumer provided permission for such processing to occur.) As shown, an information box 708 states that: “Smart preferences has completed the form using the card that is best suited for this purchase. Your Big Store MasterCard® rewards card will give you the most rewards for this transaction.” Also provided is selection button 710 that permits the consumer to: “Choose a different card with Smart Prefs” if he or she does not wish to utilize the Big Store MasterCard® that was automatically selected. If the button 710 is selected, the smart preference computer system may operate to utilize the cardholder's preferences data and other data to determine a recommendation and then present a recommended payment card account list to the cardholder for selection of a payment card account to utilize in the purchase transaction. But if the consumer wishes to consummate the purchase transaction by using the automatically selected payment card, then he or she can scroll down the webpage and select a “Pay Now” button (not shown) to transmit the payment card and transaction information to a payment network.

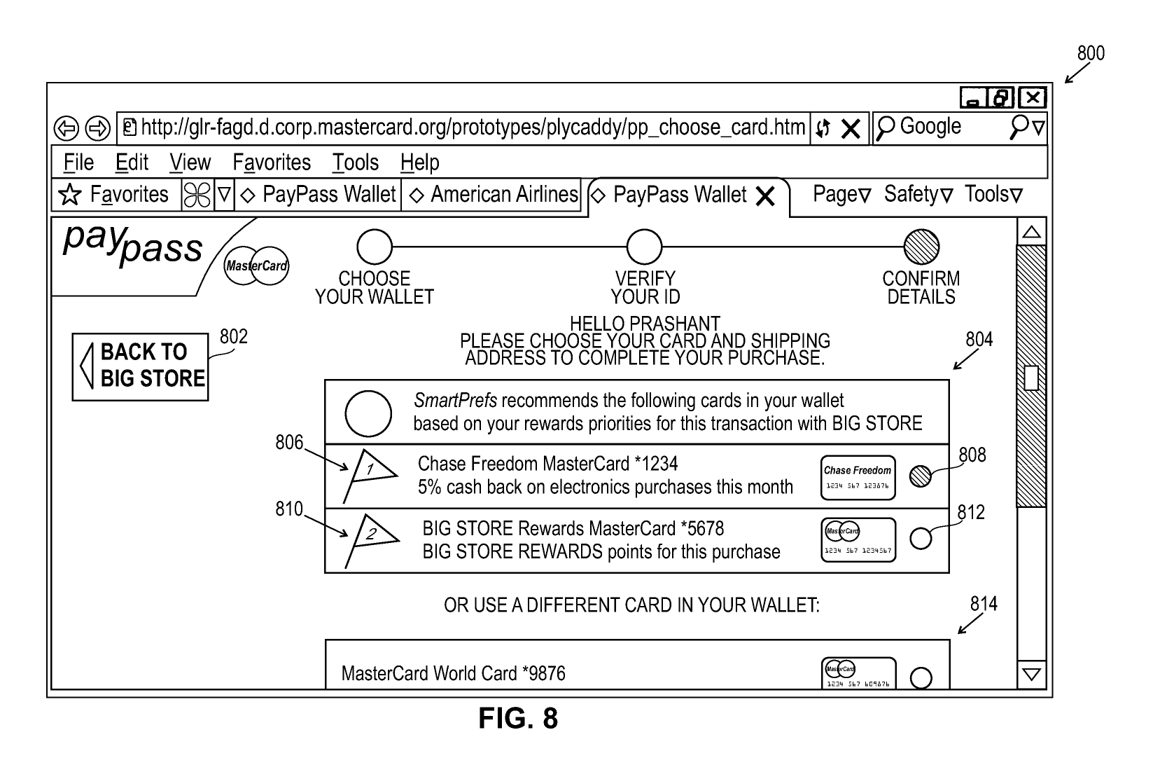

FIG. 8 is a screen shot illustrating an example of a PayPass™ Wallet confirm details webpage 800 that may be reached by a cardholder from a check-out webpage of a merchant, such as “Big Store”, illustrating recommendations provided through use of a smart preferences process according to an embodiment. The consumer has already chosen a digital wallet and verified his or her identification (by entering a password, for example). A “Back to Big Store” button 802 is provided, which the consumer can select if he or she desires to return to the check-out webpage or to continue shopping. Also shown is a dialog box 804 that provides: “Smart Prefs recommends the following cards in your wallet based on your rewards priorities for this transaction with Big Store”. The first recommended payment card account 806 is a “Chase Freedom MasterCard*1234” which provides “5% cash back on electronics purchases this month” and which can be selected by the cardholder by clicking on the radio button 808. The second recommended payment card account 810 is a “Big Store Rewards MasterCard*5678” which provides “Earn Big Store Rewards points for this purchase” and which can be selected by the cardholder or consumer by clicking on the radio button 812. If the cardholder does not wish to use either of the recommended payment cards, he or she can scroll down the webpage to see a list 814 of additional payment card accounts that could be selected in a similar manner. Once the consumer selects one of the cards (by clicking on a radio button, for example button 808), the checkout webpage of the merchant is again displayed with the selected card information that is required for the transaction automatically populated on the checkout webpage.

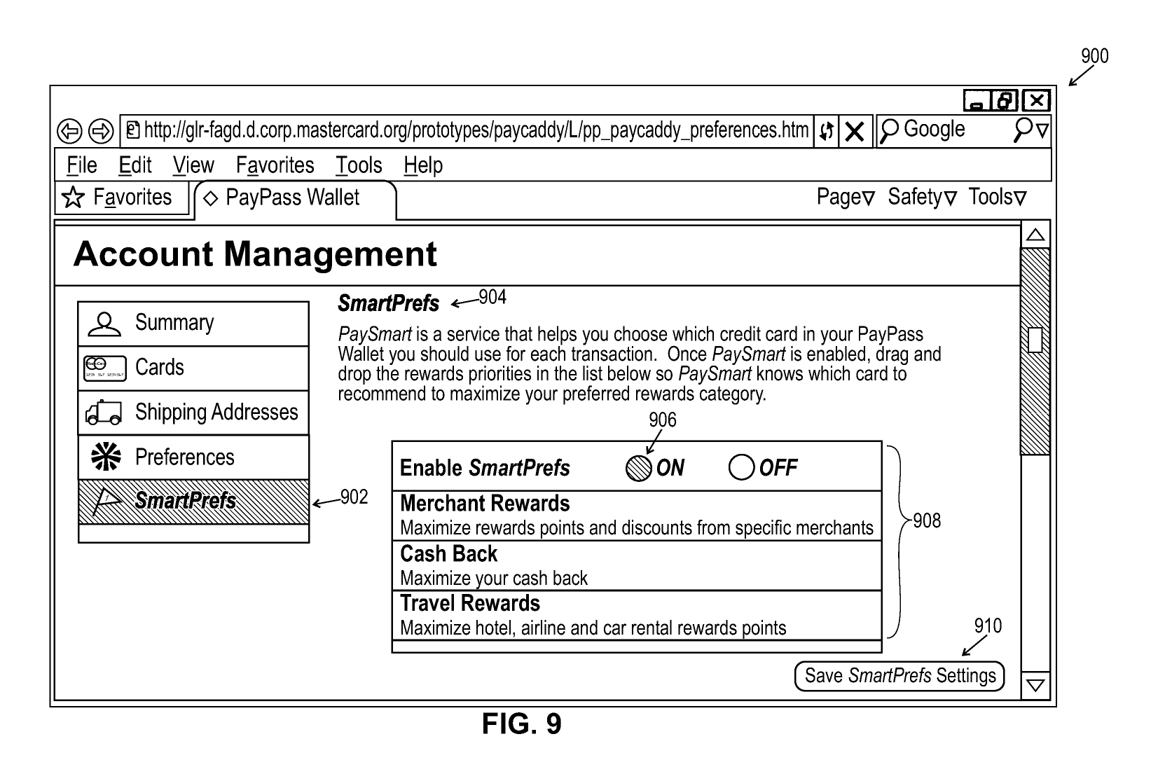

FIG. 9 is a screen shot illustrating an example of a smart preferences Account Management webpage 900 according to an embodiment. In an implementation, the Account Management webpage can be reached by a consumer by selecting a “Smart Prefs” tab 902 from his or her PayPass™ Wallet webpage. A “Smart Prefs” dialogue 904 then appears explaining that the smart preferences service helps the consumer choose which credit card or other payment card account in the PayPass™ Wallet to use for a particular purchase transaction. Once the smart preferences service is enabled (by clicking on the “ON” selection circle 906), the consumer can drag and drop the rewards priorities in the list 908 so that the smart preferences system can determine which card(s) to recommend for a particular purchase transaction to maximize the consumer's preferred rewards category or categories. Once all selections are made, the consumer clicks on the “Save Smart Prefs Settings” button 910 to save the priority list.

The flow charts and descriptions thereof herein should not be understood to prescribe a fixed order of performing the method steps described therein. Rather the method steps may be performed in any order that is practicable.

As used herein and in the appended claims, the term “payment card account” includes a credit card account or a deposit account that the account holder may access using a debit card or a gift card account. The term “payment card account number” includes a number that identifies a payment card account or a number carried by a payment card, or a number that is used to identify an account in a payment system that handles debit card and/or credit card transactions or to route a transaction in a payment system that handles debit card and/or credit card transactions. The term “payment card” includes a credit card or a debit card (including a pre-paid debit card) or a gift card. The term “payment card account” also includes an account to which a payment card account number is assigned. Thus a payment card account may include an account to which payment transactions may be routed by a payment system that handles debit card and/or credit card and/or gift card transactions, even if the account in question is not eligible to be charged for purchase transactions or other transactions. A payment card account may also include an account from which payment transactions may be routed by a payment system that handles debit card and/or credit card and/or gift card transactions, even if the account in question is not customarily used, or is not eligible, to be charged for purchase transactions.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving, by a processor, service call data associated with a purchase transaction;
determining, by the processor, that a cardholder associated with the purchase transaction is a registered smart preferences user;
accessing, by the processor, smart preferences cardholder profile data which includes preferences data, digital wallet data including cardholder product data, and cardholder benefits data;
determining, by the processor, based on the preferences data, the cardholder product data, and the cardholder benefits data, a recommendation of at least one payment card account to select for use in the purchase transaction; and
transmitting, by the processor, the recommendation to a device for consideration and selection of a payment card account by the cardholder.

2. The method of claim 1, wherein, prior to transmitting the recommendation:
determining, by the processor, that the cardholder granted permission to transmit payment card account data associated with a best choice payment card account recommendation directly to a merchant; and
transmitting, by the processor, the best choice payment card account data to the merchant to consummate the purchase transaction.

3. The method of claim 2, further comprising transmitting the best choice payment card account recommendation to the cardholder.

4. The method of claim 1, further comprising, transmitting instructions to a cardholder mobile device to cause the cardholder's mobile device to audibly present the recommendation.

5. The method of claim 1, further comprising, before determining that the cardholder is a registered smart preferences user:
determining, by the processor, that the cardholder is not enrolled as a smart preferences user;
prompting the cardholder to provide smart preferences registration data;
receiving, by the processor, a negative indication from the cardholder;
accessing, by the processor from a cardholder device, digital wallet data including cardholder product(s) data;
accessing benefits data from a database;
determining, by the processor, based on the digital wallet data and the benefits data, a recommendation of at least one payment card account to select for use in the purchase transaction; and
transmitting, by the processor, the recommendation to a device for consideration and selection of a payment card account by the cardholder.

6. The method of claim 1, further comprising, prior to transmitting the recommendation:
determining, by the processor, a cardholder payment account ranking depending on at least one of a preference order provided by the consumer, benefits associated with the payment card accounts of the cardholder, crowd intelligence data, and derived intelligence data;
generating a ranked list of cardholder payment accounts; and
transmitting, by the processor, at least a portion of the ranked list of cardholder payment accounts for consideration and selection of a payment card account by the cardholder.

7. The method of claim 1, further comprising, prior to determining a recommendation:
accessing, by the processor, annual percentage rate (APR) data and current payment card balance data of the payment card accounts of the cardholder;
determining that at least one payment card account includes at least one of a high APR and a high current account balance; and
eliminating, by the processor, the at least one payment card account having at least one of the high APR and the high current account balance from consideration as a recommended payment card account.

8. The method of claim 1, wherein the service call data comprises at least one of consumer data, a merchant identifier, location data, a transaction time and date, line item data associated with items or services being purchased, and communications data.

9. The method of claim 1, further comprising, prior to receiving service call data:
receiving, by the processor, cardholder smart preferences registration data; and
storing, by the processor, the cardholder smart preferences registration data for use in generating payment card account recommendations for use with purchase transactions.

10. The method of claim 9, wherein the cardholder smart preferences registration data comprises at least one of basic cardholder information, mobile device information, information concerning at least two payment card accounts, family member payment card account information, and cardholder preferences information.

11. An apparatus comprising:
a processor;
a non-transitory computer medium operably coupled to the processor, the non-transitory computer medium storing instructions configured to cause the processor to:
receive service call data associated with a purchase transaction;
determine that a cardholder associated with the purchase transaction is a registered smart preferences user;
access smart preferences cardholder profile data which includes preferences data, digital wallet data including cardholder product data, and cardholder benefits data;
determine based on the preferences data, the cardholder product data, and the cardholder benefits data, a recommendation of at least one payment card account to select for use in the purchase transaction; and
transmit the recommendation to a device for consideration and selection of a payment card account by the cardholder.

12. A method comprising:
receiving, by a processor, service call data associated with a purchase transaction;
determining, by the processor, that the cardholder is not enrolled as a smart preferences user;
prompting the cardholder to provide smart preferences registration data including cardholder profile data, cardholder preferences data, and digital wallet data including cardholder product data;
receiving the cardholder smart preferences registration data;
storing, by the processor, the cardholder smart preferences registration data;
accessing, by the processor, card benefits data based on the cardholder product data;
determining, by the processor based on the cardholder preferences data, the cardholder product data, and the cardholder benefits data, a recommendation of at least one payment card account to select for use in the purchase transaction; and
transmitting, by the processor, the recommendation to a device for consideration and selection of a payment card account by the cardholder.

13. The method of claim 12, wherein storing the cardholder smart preferences data comprises at least one of loading the cardholder smart preferences data in a secure storage location of the consumer's mobile device, loading the cardholder smart preferences data in a secure storage location of the consumer's personal computer, and loading the cardholder smart preferences data in a remote cardholder smart preferences database.

14. The method of claim 12, wherein, prior to transmitting the recommendation:
determining, by the processor, that the cardholder granted permission to transmit best choice payment card account data directly to a merchant; and
transmitting, by the processor, the best choice payment card account data to the merchant to consummate the purchase transaction.

15. The method of claim 12, further comprising, transmitting instructions to a cardholder mobile device to cause the cardholder's mobile device to audibly present the recommendation.

16. The method of claim 12, further comprising, prior to transmitting the recommendation:
determining, by the processor, a cardholder payment account ranking depending on at least one of a preference order provided by the consumer, benefits associated with the payment card accounts of the cardholder, crowd intelligence data, and derived intelligence data;
generating a ranked list of cardholder payment accounts; and
transmitting, by the processor, at least a portion of the ranked list of cardholder payment accounts for consideration by the cardholder.

17. The method of claim 12, further comprising, prior to determining a recommendation:
accessing, by the processor, annual percentage rate (APR) data and current payment card balance data of the payment card accounts of the cardholder;
determining that at least one payment card account includes at least one of a high APR and a high current account balance; and
eliminating, by the processor, the at least one payment card account having at least one of the high APR and the high current account balance from consideration as a recommended payment card account.

18. The method of claim 12, wherein the service call data comprises at least one of consumer data, a merchant identifier, location data, a transaction time and date, line item data associated with items or services being purchased, and communications data.

19. The method of claim 12, wherein the cardholder smart preferences registration data further comprises at least one of cardholder mobile device information and family member payment card account information.

20. The method of claim 12, wherein the device is a cardholder mobile device comprises at least one of a mobile telephone, a tablet computer and a laptop computer.

21. An apparatus comprising:
a processor;
a non-transitory computer medium operably coupled to the processor, the non-transitory computer medium storing instructions configured to cause the processor to:
receive service call data associated with a purchase transaction;
determine that the cardholder is not enrolled as a smart preferences user;
prompt the cardholder to provide smart preferences registration data including cardholder profile data, cardholder preferences data, and digital wallet data including cardholder product data;
receive the cardholder smart preferences registration data;
store the cardholder smart preferences registration data;
access card benefits data based on the cardholder product data;
determine, based on the cardholder preferences data, the cardholder product data, and the cardholder benefits data, a recommendation of at least one payment card account to select for use in the purchase transaction; and
transmit the recommendation to a device for consideration and selection of a payment card account by the cardholder.
